(19) United States
(12) Patent Application Publication
(10) Pub. No.: US 2005/0225774 A1
(43) Pub. Date: Oct. 13, 2005

(54) Method for measuring and manufacturing an optical element and optical apparatus

(75) Inventors: Rolf Freimann, Aalen (DE); Susanne Beder, Aalen (DE); Guenther Seitz, Spiegelberg (DE); Frank Schillke, Aalen (DE); Bernd Doerband, Aalen (DE); Heinz Martin, Koenigsbronn (DE); Franz Krug, Aalen-Ebnat (DE)

Correspondence Address: JONES DAY, 2882 SAND HILL ROAD, SUITE 240, MENLO PARK, CA, 94025, US

(73) Assignee: Carl Zeiss SMT AG, Oberkochen (DE)

(21) Appl. No.: 11/098,546

(22) Filed: Apr. 5, 2005

(30) Foreign Application Priority Data
Apr. 5, 2004 (DE) 10 2004 016 737.0

(51) Int. Cl. G01B 9/02

(52) U.S. Cl. 356/515

(57) ABSTRACT

A method of processing an optical element comprises testing the optical surface of the optical element using an interferometer optics for generating a beam of measuring light; wherein the interferometer optics has a plurality of optical elements which are configured and arranged such that the measuring light is substantially orthogonally incident on a reflecting surface, at each location thereof; and wherein the method further comprises: measuring at least one property of the interferometer optics, disposing the optical surface of the optical element at a measuring position relative to the interferometer optics within the beam of measuring light, and performing at least one interferometric measurement; determining deviations of the optical surface of the first optical element from a target shape thereof, based on the interferometric measurement and the at least one measured property of the interferometer optics.

This application claims priority under 35 U.S.C. 119 to German Patent Application No. 10 2004 016 737.0 filed Apr. 5, 2004, the entire contents of which are incorporated herein by reference.

### BACKGROUND OF THE INVENTION

1. Field of the Invention

The present invention relates to method for processing an optical element having an optical surface of a target shape. Particularly, the invention relates to measuring and manufacturing optical elements having surfaces of an aspherical shape. Further, the invention relates to an optical apparatus having at least two lenses and a mounting structure for adjustably supporting at least one of the lenses.

2. Brief Description of Related Art

An optical element having an optical surface may comprise, for example, an optical component such as an optical lens or an optical mirror used in optical systems, such as telescopes used in astronomy, and systems used for imaging structures, such as structures formed on a mask or reticle, onto a radiation sensitive substrate, such as a resist, in a lithographic method. The success of such an optical system is substantially determined by the accuracy with which the optical surface can be machined or manufactured to have a target shape determined by a designer of the optical system when designing the optical system. In such manufacture it is necessary to compare the shape of the machined optical surface with its target shape, and to determine differences or deviations between the machined surfaces and target surfaces. The optical surface may then be further machined at those portions where differences or deviations between the machined and target surfaces exceed e.g. predefined thresholds.

Interferometric apparatuses are commonly used for high precision measurements of optical surfaces. Examples of such apparatus are disclosed in U.S. Pat. No. 4,732,483, U.S. Pat. No. 4,340,306, U.S. Pat. No. 5,473,434, U.S. Pat. No. 5,777,741, U.S. Pat. No. 5,488,477. The entire contents of these documents are incorporated herein by reference.

The conventional interferometer apparatus for measuring a spherical optical surface typically includes a source of coherent light and an interferometer optics for generating a beam of measuring light. The measuring light is incident on the surface to be tested, such that wavefronts of the measuring light have, at a position of the surface to be tested, a same shape as the target shape of the surface under test. In such a situation, the beam of measuring light is orthogonally incident on the surface under test, and is reflected therefrom to travel back towards the interferometer optics. Thereafter, the light of the measuring beam reflected from the surface under test is superimposed with light reflected from a reference surface. Differences and deviations of the shape of the surface under test and its target shape are determined from a resulting interference pattern.

While spherical wavefronts for testing spherical optical surfaces may be generated with a relatively high precision by conventional interferometer optics, more advanced methods are necessary to generate beams of measuring light having aspherical wavefronts such that the light is substantially orthogonally incident at each location of the aspherical surface under test. In order to form such beams of measuring light optics are used which are referred to as compensators, null lens arrangements, or K-systems. Background information relating to null lens arrangements or compensators is available e.g. from the text book of Daniel Malacara “Optical Shop Testing”, 2^{nd} Edition, John Wiley & Sons, Inc. 1992, Chapter 12.

When an optical element having a surface of a predetermined aspherical target shape is to be manufactured an interferometer having a null lens arrangement is to be employed. Such interferometer generates a beam of measuring light having wavefronts which at a certain location along the beam have an aspheric shape which corresponds exactly to the shape of the aspherical optical surface to be manufactured. For a plurality of types of aspherical optical surfaces a design for a corresponding null lens arrangement can be developed using one or more lenses. Thus, the developed null lens arrangement is specified with respect to vertex distances, radii of curvatures, effective diameters of surfaces individual lenses of the null lens arrangement as well as glass types from which these lenses are to be manufactured. Then the plural necessary lenses will be manufactured having a required precision and will be assembled to constitute the null lens arrangement.

The null lens arrangement assembled as described above will then be used to measure the optical surface to be manufactured, to determine deviations of the optical surface from a target shape thereof and based on the determined deviations to process the optical surface to be manufactured, to approximate the actual shape to the target shape.

It has been found that aspherical lenses being produced by using such conventional methods in practice do not meet high requirements concerning their effect in an optical system in which they are to be integrated. A further problem concerning conventional types of interferometers is to provide a fine adjustment of the optical elements comprising the interferometer to an extent which is substantially less than a movement as performed by conventional actuators.

### SUMMARY OF THE INVENTION

The present invention has been accomplished taking the above problems into consideration.

Embodiments of the present invention provide a method of processing an optical surface of an optical element by which an optical surface of the optical element can be measured and manufactured with a high precision in a relatively simple manner.

Further embodiments of the invention provide an optical apparatus for providing a fine adjustment of optical elements with respect to each other.

The foregoing objects are accomplished by providing a method of processing an optical element having an optical surface. The method comprises testing the optical surface of the optical element using an interferometer, wherein the interferometer comprises an interferometer optics for generating a beam of measuring light, and wherein the interferometer optics has a plurality of optical elements which are configured and arranged such that the measuring light is substantially orthogonally incident on a reflecting surface, at each location thereof, the reflecting surface being disposed at a predetermined distance from the interferometer optics in the beam of measuring light. The reflecting surface might be an optical surface of a mirror to be manufactured, i.e. a mirror surface, but the reflecting surface could also be an optical surface of a lens to be manufactured, if special attention is paid to the shape of one or both of its optical surfaces.

The method further comprises measuring at least one property of the interferometer optics, wherein the at least one property comprises at least one of: a parameter of a shape of an optical surface of at least one optical element of the plurality of optical elements of the interferometer optics, a distance between two different optical surfaces of the interferometer optics, and an index of refraction of at least a portion of a medium disposed between two adjacent optical surfaces of the interferometer optics.

The method further comprises disposing the optical surface of the optical element at a measuring position relative to the interferometer optics within the beam of measuring light, performing at least one interferometer measurement by superimposing reference light with measuring light reflected from the reflecting surface, and determining deviations of the optical surface of the optical element from a target shape thereof, based on the interferometric measurement and the at least one measured property of the interferometer optics. Thus, it is possible to process the optical surface of the optical elements based on the determined deviations in order to approximate the optical surface of the optical element to a predetermined target shape.

In an embodiment of the present invention, at least one property, especially a physical property of the interferometer optics, is independently measured. Further, deviations of the optical surface of the optical element from a target shape thereof are determined not only based upon the result of the interferometric measurement but also based upon the at least one measured property.

Conventional methods compare the shape of the optical surface of the optical element to be manufactured with the shape of the wavefronts of the beam of measuring light generated by the interferometer optics. It is thus necessary to generate the shape of the wavefronts of the beam of measuring light with an according high precision. But in practice, it is often difficult or even impossible to qualify the shape of the wavefronts of the beam of measuring light generated by the interferometer optics. Thus, a high degree of uncertainty exists whether or not an interferometer optics meets the imposed requirements.

Therefore, in order to determine deviations of the optical surface of the optical element from a target shape thereof, a given shape of the wavefronts of the beam of measuring light is not simply taken as given. Instead, according to embodiments of the invention, an independent physical property of the interferometer optics, which property especially does not comprise the shape of the wavefronts of the beam of measuring light, is independently determined. This property or a measured value representing this property will then be taken into account for determining deviations of the optical surface of the optical element from a target shape thereof.

The at least one property comprises properties of the interferometer which can be determined independently. Especially those parameters or geometric properties will be used, which are predetermined by the design of the interferometer and especially the design of the interferometer optics. Examples for parameters of the shape of the optical surface of at least one optical element of the plurality of optical elements of the interferometer optics comprises a radius of curvature of an optical surface of the optical element of the interferometer optics, when the optical element of the interferometer optics is a lens. A further parameter might be a distance between optical surfaces of adjacent lenses of the interferometer optics, particularly a vertex distance.

Further, the parameter of the shape of the optical surface of the optical element of the interferometer optics comprises a deviation of the optical surface of the lens from a target shape thereof, wherein the target shape of the optical surface of the lens of the interferometer optics is predetermined by a design of the interferometer optics.

Another example for measuring one property of the interferometer optics comprises measuring an index of refraction of a material of the lens at plural different locations. The measuring of the property of the interferometer optics can also comprise determining properties of a gas disposed between two adjacent optical surfaces. For example determining a temperature, a pressure, or a humidity of the gas yields information about a property especially an optical property of the gas. The temperature, the pressure, and the humidity of the gas can be measured by conventional sensing devices or can be determined indirectly in different manners, which are known in the art, the detailed description of these being therefore omitted here.

According to an exemplary embodiment of the present invention the determining of the deviations of the optical surface of the optical element from the target shape thereof comprises: changing design data (e.g., received, measured, or otherwise generated design data) of the interferometer optics, wherein the design data is specified by a design of the interferometer optics, and wherein changing the design data is based on the at least one measured property, and performing a ray tracing computation of the beam of the measuring light traversing the interferometer optics based on the changed design data of the interferometer optics. The method of ray tracing permits simulating or computing of the shapes of the wavefronts of the beam of measuring light generated by the interferometer optics. The result depends on the selection of optical parameters and shape parameters of the simulated system on which parameters the computation will be based. When using the design parameters of the optical system for the computation, a result of the ray tracing computation should yield shapes of wavefronts which substantially exactly correspond to the target shape of the optical surface to be measured, because the interferometer optics is designed with respect to the generation of these wavefronts.

Software packages for performing such ray tracing computations are available, as for example the product CODE V from Optical Research Associates, Pasadena, Calif. or the product ZEMAX from ZEMAX Development Corporation, San Diego, Calif., and similar products.

As in practice the interferometer optics cannot be manufactured having exactly the properties as given by the design of the interferometer optics, the wavefronts generated by the real interferometer optics will deviate from their target shape. For example, a vertex distance between two adjacent lenses of the interferometer optics might not precisely correspond to the preset distance, given by the design of the optics; already by this reason deviations of the wavefronts from a target shape thereof might arise. However, this vertex distance can be measured independently as a property of the interferometer optics, and then, instead of using the distance between the both lenses as given by design, the independently measured vertex distance will be used as a basis for the ray tracing computation. Thus, the shape of the wavefronts of the beam of measuring light generated by the actual interferometer as determined by ray tracing computation will better match the actual wavefronts than the originally assumed target shape of the wavefronts. It is thus possible, to take into account the calculated wavefronts, which are calculated by ray tracing computation based on the at least one measured property, when evaluating the interferometric measurement. It is thus possible to determine deviations of the optical surface of the optical element from the target shape thereof with a higher precision.

According to an exemplary embodiment the optical surface of the optical element provides the reflecting surface when the optical surface of the optical element is disposed substantially at the measuring position in the beam of measuring light. By this, the beam of measuring light will be reflected back, i.e., the optical surface to be measured will be measured in reflection.

According to an alternative embodiment the reflecting surface is separate from the optical surface of the optical element and the optical element is traversed by the beam of measuring light when the optical surface of the optical element is disposed substantially at the measuring position in the beam of measuring light. This means, the optical surface is measured in transmission.

The method is particularly suitable for measuring an optical surface having an aspherical shape. But the method is not limited thereto, and also optical surfaces having spherical shapes can be measured using this method.

Within the scope of the present invention, an optical surface maybe referred to as an aspherical surface, if the aspherical surface differs from its best approximating sphere by more than a predetermined criterion. One such criterion is based on a gradient of the difference between the aspherical surface and its best approximating sphere, and the optical surface is referred to as an aspherical surface if such gradient exceeds a value of 6 μm divided by an effective diameter of the optical surface.

According to an exemplary embodiment the interferometer optics has a reference surface which reflects the reference light, and which is traversed by the beam of measuring light. Such a reference surface is particularly provided within interferometers of Fizeau type.

According to a further exemplary embodiment the method comprises processing the optical surface of the optical element-based on the determined deviations. The processing can particularly be directed to approximating the optical surface to the target shape thereof. Particularly, the processing might be performed only if the determined deviations exceed at least one predetermined threshold.

Such a processing can comprise at least one of milling, grinding, loose abrasive grinding, polishing, ion beam figuring, magneto-rheological figuring, and finishing the optical surface of the optical element, wherein the finishing can comprise applying a coating to the optical surface of the optical element, especially at least one of a reflective coating, an anti-reflective coating, and a protective coating.

According to a second aspect, embodiments of the invention provide a method of processing a further optical element having an optical surface. The method comprises providing a first optical element having an optical surface of substantially a predetermined target shape by: measuring the optical surface of the first optical element using the method as set forth above for determining deviations of a shape of the optical surface of the first optical element from its predetermined target shape, and processing the optical surface of the first optical element based on the determined deviations for reducing the deviations of the shape of the optical surface of the first optical element from its predetermined target shape. The method further comprises incorporating (e.g., mounting) the first optical element in a second interferometer; performing a second interferometric measurement of the optical surface of the second optical element using the second interferometer; and determining deviations of the optical surface of the second optical element from its target shape based on the second inter ferometric measurement. According to an exemplary embodiment the method further comprises processing the optical surface of the second optical element based on the determined deviations of the optical surface of the second optical element from its target shape.

According to a further aspect, embodiments of the invention provide an optical apparatus, comprising at least two lenses and a mounting structure adapted to support the at least two lenses relative to each other, wherein the mounting structure is configured such that at least one of a distance between two adjacent lenses of the at least two lenses and a relative orientation of the two adjacent lenses is adjustable; wherein at least one lens of the at east two lenses has a curved optical surface; wherein the mounting structure provides three supporting locations engaging the curved surface for supporting the lens having the curved optical surface; wherein each of the supporting locations is provided at a respective end of an adjustment member (e.g., at a respective end of a threaded bolt); wherein the mounting structure provides three support portions, wherein each of the support portions supports a respective adjustment member (e.g., wherein the mounting structure provides three threaded portions, wherein each of the threaded portions is in threaded engagement with a respective threaded bolt); wherein the adjustment members (e.g., threaded bolts) are oriented such that central axes (e.g., longitudinal axes) of the three adjustment members define a smallest first mathematical sphere having the central axes as tangent lines thereto, wherein the three supporting locations define a smallest second mathematical sphere extending to the three supporting locations, and wherein a first diameter of the smallest first mathematical sphere is less than half of a second diameter of the smallest second mathematical sphere.

For example, when only one of the threaded bolts is actuated, its corresponding supporting location will move readily. As the supporting location supports the curved optical surface of the lens, the lens will experience a tilting effect. On the contrary, when actuating all three bolts by a same amount the lens will experience a translation which is substantially in the direction of the optical axis of the lens. The threaded portions, and likewise the threaded bolts, might be arranged regularly, such that the central axis of the three threaded portions are within one same plane and intersecting within a central point, defined by equal distances to the threaded portions. But the threaded portions and bolts might also be oriented in a more general manner, which might be of advantage, when actuators requiring a substantial amount of space have to be used to actuate the threaded bolts. Thus it is an advantage when a first diameter of a smallest first mathematical sphere which has the central axes of the three adjustment members (e.g., threaded bolts) as tangents is less than half of a smallest second mathematical sphere on the surface of which the three supporting locations are located.

According to an exemplary embodiment the three central axes of the adjustment members (e.g., threaded bolts) each extend transversely to an optical axis of the lens having the curved surface.

According to a further exemplary embodiment the at least two lenses have a substantially common optical axis and the adjustment members (e.g., threaded bolts) each extend substantially transverse to the common optical axis.

According to a further exemplary embodiment the first diameter is substantially zero, meaning that the first diameter of the smallest first mathematical sphere equates to zero to within the limitations of conventional machining tolerances.

According to another exemplary embodiment the ends of the adjustment members (e.g., threaded bolts) have convex surfaces, providing the supporting locations. Thus, the optical surface of the lens will be scratched only to an inevitable extent. The convex surfaces of the ends of the adjustment members might also be realized by a suitable ball bearing.

According to a further aspect of the invention an interferometer comprises a light source for generating a beam of measuring light; and an interferometer optics providing a beam path of the beam of the measuring light; wherein the interferometer optics comprises the optical apparatus as set forth above.

### BRIEF DESCRIPTION OF THE DRAWINGS

The foregoing as well as other advantageous features of the invention will be more apparent from the following detailed description of exemplary embodiments of the invention with reference to the accompanying drawings. It is noted that not all possible embodiments of the present invention necessarily exhibit each and every, or any, of the advantages identified herein.

FIG. 1 is a schematic illustration of an interferometer for measuring an optical surface according to an embodiment of the invention;

FIG. 2a and FIG. 2b show deviations of wavefronts of a beam of measuring light generated by the interferometer according to FIG. 1 from their target shape;

FIG. 3 shows a flowchart of a method for manufacturing an optical element, the optical surface being measured using the interferometer shown in FIG. 1;

FIG. 4 shows a schematic illustration of a further interferometer for manufacturing an optical element according to an embodiment of the invention;

FIG. 5 shows a schematic illustration of a further interferometer for using a method for manufacturing an optical element according to an embodiment of the invention, wherein an optical surface of the optical element to be manufactured is measured in transmission;

FIG. 6 is a schematic illustration of a mounting structure of an optical apparatus, seen from a side;

FIG. 7a is a schematic illustration of a general condition of the adjustment members (e.g., threaded bolts) of the optical apparatus, seen from a side;

FIG. 7b is a schematic illustration according to FIG. 7a seen from above;

FIG. 7c shows a geometric relationship of general orientations of the adjustment members (e.g., threaded bolts) with respect to each other;

FIG. 8 shows a portion of FIG. 6 for explaining a mode of action of the threaded bolts; and

FIG. 9 is a schematic illustration of selected geometric relationships which exist in the optical apparatus and on which the determination of a thread pitch of the threaded bolts is based.

### DETAILED DESCRIPTION OF EXEMPLARY EMBODIMENTS

In the exemplary embodiments described below, components that are alike in function and structure are designated as far as possible by alike reference numerals. Therefore, to understand the features of the individual embodiments and their components, the descriptions of other embodiments and their components and of the summary of the invention should be referred to.

The embodiments described below utilize interferometric measurement techniques. Suitable interferometric measurment techniques are known in the art, such as, for example, the interferometric measurement techniques are described in U.S. Pat. No. 5,361,312, U.S. Pat. No. 5,982,490, and U.S. 2002/0063867 A1. The entire contents of these documents are incorporated herein by reference.

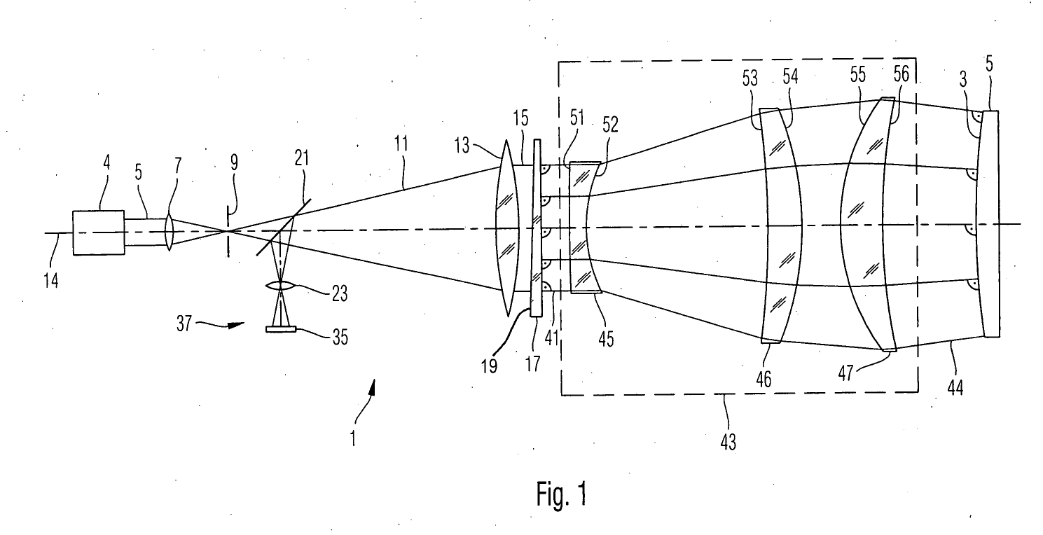

FIG. 1 shows an interferometer system 1 for measuring an aspherical reflecting surface 3, or aspherical mirror surface 3, of a mirror 5. The interferometer system 1 comprises a light source 4, as for example a helium neon laser, which emits a beam of laser light 14. The beam of laser light 14 is focussed by a focussing lens 7 onto a pin hole of a beam stop 9, such that a diverging beam of measuring light 11 of coherent light emanates from the pin hole. Wavefronts in the diverging beam 11 are of substantially spherical shape. The diverging beam 11 is collimated by one or more lenses 13 to a parallel beam 15, having wavefronts of a substantially plane shape. The beam 15 traverses a wedge shaped plate 17, which comprises a surface 19, which is oriented orthogonal relative to the direction of the beam 15. The surface 19 is a Fizeau surface of the interferometer system 1 such that a part of the beam 15 is reflected back from the Fizeau surface 19, traverses the lens 13, is reflected as converging beam at a beam splitter 21, and is guided via an objective 23 onto a light sensitive substrate 35 of a camera 37.

A portion 41 of the beam 15 traversing the Fizeau surface 19 enters the interferometer optics 43 and is shaped to a beam of measuring light 44. This beam of measuring light 44 emerges from the interferometer optics 43 and has wavefronts formed in such a manner, that they are substantially orthogonally incident on the reflecting surface 3 at each location thereof. The light of the beam of measuring light 44 will then be reflected from the reflecting surface 3 to travel back towards the interferometer optics 43, is formed by the interferometer optics 43 to be a beam having substantially plane wavefronts, traverses the Fizeau surface 19, and is guided via the collimating lens 13, the beam splitter 21 and the objective 23 onto the substrate 35 of the camera 37. On the photosensitive substrate 35 the superimposing of the reference light which is reflected from the Fizeau surface 19 and the measuring light which is reflected from the reflecting surface 3 results in an interference pattern. The evaluation of this interference pattern permits determining the shape of the reflecting surface 3. Concerning the incidence angle of the wavefronts on the reflecting surface 3, the phrase “substantially orthogonally” does not necessarily mean perfectly orthogonally, but rather, that the wavefronts are incident on the reflecting surface 3 close enough to orthogonally such that the resulting interference pattern has suitably discernible interference fringes that allow determining a shape of the reflecting surface.

The interferometer optics is also referred to as a null lens arrangement, a K-system, or a compensator. The interferometer optics is adapted to form the plane waves of the beam 41 entering into the optics 43 into wavefronts of the beam 44, such that their shape at the location of the reflecting surface 3 substantially coincides with the target shape of the reflecting surface 3. Being designed for this the interferometer optics 43 comprises three lenses 44, 46, 47, comprising lens surfaces 51 to 56, which are arranged one after the other within the interferometer optics 43.

The aspherical reflecting surface 3 is characterized by the following equation, which is conventionally referred to as “aspheric equation”:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{8} {r}^{14}$$

Herein said z presents the z-coordinate of the surface of the optical element at a distance r taken from the optical axis 14, c is the curvature of the aspherical surface, k is the conical constant, and αᵢ are further coefficients. Exemplary values of parameters of the equation for the reflecting surface 3 are shown in the following Table 1:

TABLE 1

| Parameter | Value | |
|---|---|---|
| Tr | +668.5512 | mm |
| c | 1/r = 1.49577 · 10⁻³ | mm⁻¹ |
| k | 0 | |
| α₁ | 0 | |
| α₂ | −2.946315 · 10⁻⁹ | mm⁻³ |
| α₃ | 8.333468 · 10⁻¹⁴ | mm⁻⁵ |
| α₄ | 1.08029510⁻¹⁷ | mm⁻⁷ |

Exemplary corresponding optical data of the interferometer optics 43 are shown in the following Table 2. Herein the first column designates the number of the lens surface according to FIG. 1, the second column designates the designation of the medium between adjacent lens surfaces, according to product names of the company Schott, Mainz, Germany, from which the glasses are available, the third column designates the index of refraction of the medium between the adjacent lens surfaces, the fourth column designates the respective effective diameter of the lens surface, the fifth column designates their radius of curvature and the sixth column designates the vertex distance between the adjacent lens surfaces.

TABLE 2

| | | Index of | Radius | Thickness | Diameter |
|---|---|---|---|---|---|
| Surface | Glass | refraction | [mm] | [mm] | [mm] |
| 51 | BK7 | 1.5157 | 865.3256 | 15.9 | 122.7531 |
| 52 | | | 122.326 | 176.1565 | 121.3113 |
| 53 | SFL6 | 1.79861 | −739.1095 | 29.45 | 210.4361 |
| 54 | | | −290.084 | 37.5922 | 217.5501 |
| 55 | BK7 | 1.515517 | 196.6741 | 39.6 | 234.7853 |
| 56 | | | 480.135 | 84.7751 | 229.3078 |
| 8 | | | 668.5512 | 0 | 204.4986 |

The data given in Table 2 are the design data for the optical parameters of the interferometer optics 43, i.e. these data are calculated by a designer of the interferometer optics, with the objective that the wavefronts of the beam of measuring light 44, emerging of the interferometer optics 43 have the desired aspherical shape.

The lenses 45 to 47 are manufactured according to the design data given in Table 2. Lens mounts for the lenses are manufactured such, that they can be supported by the lens mounts, so that the vertex distances of lens surfaces of adjacent lenses are equal to the design data given in Table 2. Then the lenses 45 to 47 are integrated into the interferometer optics 43 and the interferometer optics 43 is disposed centred to the optical axis 14, within the path of rays of the measuring beam 41.

Then, the reflecting surface 3 of the mirror 5 is disposed within the beam of measuring light 44, for performing an interferometric measurement of the reflecting surface 3. This measurement is achieved by superimposing the wavefronts being reflected back from the reflecting surface 3 with the wavefronts being reflected back from the Fizeau surface 19, at the location of the photosensitive substrate 35 of the camera 37. From the result of this interferometric measurement the shape of the reflecting surface 3 can be determined in a first approximation. This determination of the shape of the reflecting surface 3 is made with respect to the shape of the wavefronts of the beam of measuring light 44 at the location of the reflecting surface 3, whereas the shape of the wavefronts of the beam of measuring light 44 cannot be qualified independently.

In order to improve the precision of determining the shape of the reflecting surface 3 some of the properties of the interferometer optics will be measured independently.

Inhomogeneities of the lens materials of the lenses 45 to 47 can be determined using interferometric methods for inhomogeniety testing known to those of ordinary skill in the art, such as disclosed by, for example, J. Schwider et al., “Homogeneity testing by phase sampling interferometry”, APPLIED OPTICS, Vol. 24, No. 18, 3059-3061, Sep. 15, 1985, and, for example, C. Ai et al., “Measurement of the inhomogeneity of a window”, OPTICAL ENGINEERING, Vol. 30, No. 9, 1399-1404, September 1991. The entire contents of these documents are incorporated herein by reference.

The radii of curvature of the lenses can also be determined interferometrically using methods known to those of ordinary skill in the art such as, for example, the method disclosed by Lars A. Selberg, OPTICAL ENGINEERING, vol. 31, no. 9, 1961-1966, September 1992, the entire disclosure of which is incorporated herein by reference.

Vertex distances between the two lens surfaces of a lens or of lens surfaces of adjacent lenses can be measured using optical coherence tomography (OCT). Suitable OCT devices and associated methods are known to those of ordinary skill in the art, and an exemplary device for such measurements is available from FOGALE nanotech, 30900 Nimes, France, having the product name OCT-L “Fiber optic interferometric sensor for remote dimensional measurements”.

Vertex distances of the both lens surfaces of a lens or of lens surfaces of adjacent lenses can also be measured with tactile measurements using a coordinate measurement machine.

Indices of refraction of the lens materials can be measured using any suitable conventional method such as, for example, the Fraunhofer-method known to those of ordinary skill in the art.

For characterizing the interferometer system 43 of the described exemplary embodiment, the properties given in the Table 3 below were independently determined. Empty cells of Table 3 indicate that the property has not been measured independently.

TABLE 3

| | | Index of | Radius | Thickness | Diameter |
|---|---|---|---|---|---|
| Surface | Glass | refraction | [mm] | [mm] | [mm] |
| 51 | BK7 | 1.5157 | 865.3256 | 18.85 | 122.7531 |
| 52 | | | 122.326 | 176.1665 | 121.3135 |
| 53 | SFL6 | 1.79861 | −739.1095 | 29.46 | 210.4664 |
| 54 | | | −290.084 | 37.5422 | 217.5842 |
| 55 | BK7 | 1.515517 | 196.6741 | 39.602 | 234.8156 |
| 56 | | | 480.135 | 85.56072 | 229.339 |
| 8 | | | 668.5512 | 0 | 204.2819 |

In the following, the behaviour of the interferometer optics 43 is simulated with a method of ray tracing computation. The simulation is performed on the basis of the optical data given in table 3 and, as far as these are not measured independently, by the corresponding data of table 2. The simulation further requires that the wavefronts of the beam 41 entering into the interferometer optics 43 are plane wavefronts. A result of the simulation is the shape of the wavefronts of the beam 44 emerging from the interferometer optics 43 at the location of the reflecting surface 3. These shapes of the wavefronts being obtained by simulation deviate from the target shape of the reflecting surface 3 because of deviations of the actual optical parameters of the interferometer optics 43 from the designed parameters of the interferometer optics 43 (see table 1).

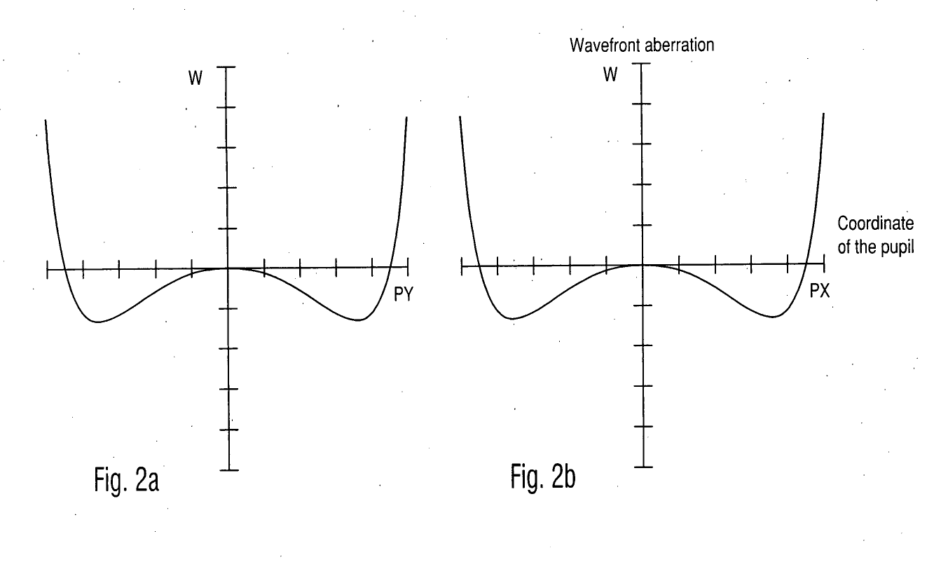

The calculated deviations are represented as a profile in x-direction (horizontal) in FIG. 2a and as a profile in y-direction (vertical) in FIG. 2b.

These wavefronts obtained by simulation are taken into account when evaluating the interferometric measurement at the reflecting surface 3, by correcting the optical path length differences obtained by the interferometric measurement by the values of the profiles at the corresponding locations x, y.

By the involving of the measured properties of the interferometer optics 43 as set forth above it is possible to improve the precision of determining the shape of the reflecting surface 3.

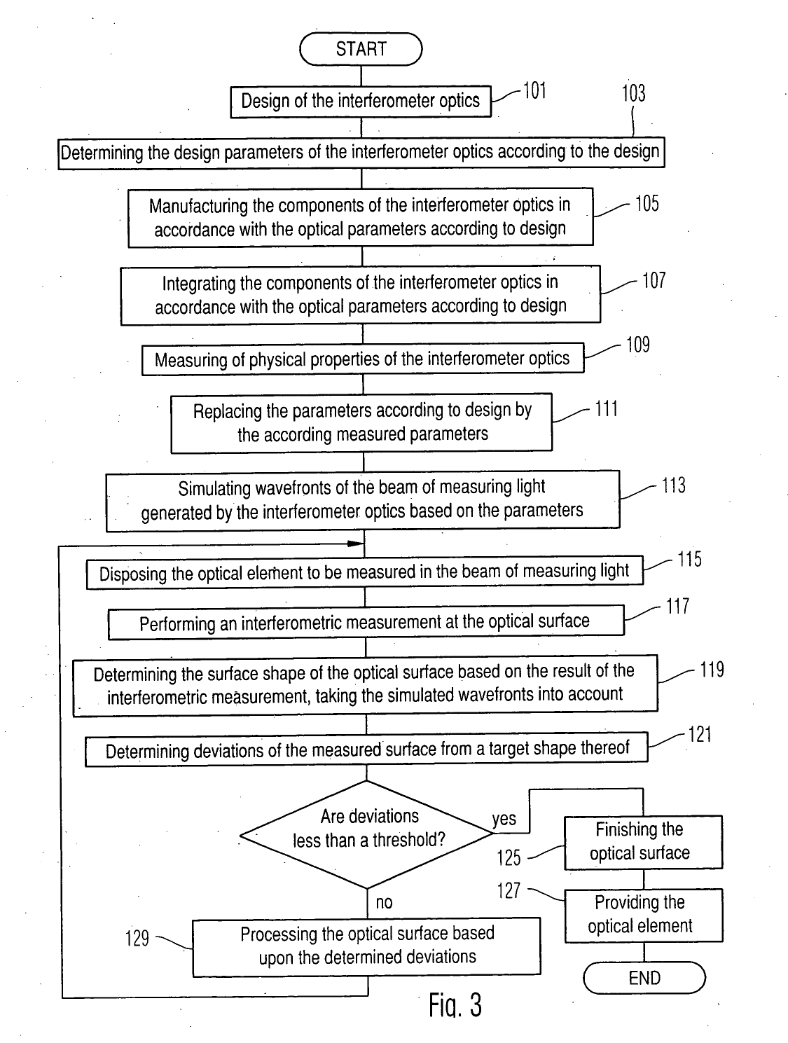

Referring to FIG. 3, the measuring method as set forth above and subsequent measures for the manufacturing of the mirror 5 will be explained below according to the flowchart, as shown in FIG. 3.

In a step 101 the interferometer optics is designed, such that it provides wavefronts which substantially are of the shape of the reflecting surface 3 to be manufactured. The properties of the interferometer optics corresponding to this design are determined in a step 103. Thereafter, the components of the interferometer optics, i.e., the lenses 45 to 47 as well as their corresponding lens mounts will be manufactured in accordance with the properties according to design (step 105). Then, the components will be assembled in a step 107, in order to provide the interferometer optics 43. Subsequently, some of the properties of the interferometer optics will be determined in a step 109. These are mainly properties, which can be determined at the assembled interferometer optics 43. Other properties, which cannot be measured at the assembled interferometer optics 43, as for example the index of refraction of the materials of the lenses or inhomogeneities of indices of refraction, can be determined before the assembly of the components to constitute the interferometer optics.

Subsequently, a data set will be drawn up which can be used as an input for a software program being adapted to perform calculations with respect to optical designs. Into the data set the design optical parameters as well as further properties of the interferometer optics according to the design (table 2) will be entered. Further, properties which have been measured independently in the step 109 (table 3) will be replaced by the measurement results (table 3) in a step 111. Then, in a step 113, the software program calculates the shapes of the wavefronts of the beam of the measuring light 44 which emerge from the interferometer optics 43, when supplied with a beam of planar wavefronts. The calculated shapes of the wavefronts deviate from their target shape, whereas the target shape was an objective of the design of the interferometer optics in step 101. These calculated deviations are shown in FIGS. 2a and 2b.

Subsequently, in a step 115, the mirror 5 is disposed in the beam of measuring light 44 and at least one interferometric measurement at the reflecting surface 3 is performed in a step 117. In a step 119 the shape of the reflecting surface will be determined based on the result of the interferometric measurement, using the simulated wavefronts of step 113.

Based on the shape of the reflecting surface 3, measured as set forth above, deviations from a target shape of the reflecting surface 3 will be determined in a step 121. If the deviations are smaller than a predetermined threshold in a step of decision 123, the reflecting surface 3 to be manufactured is determined to correspond to its specification, and a finishing of the reflecting surface 3 will be performed in a step 125. After this, the mirror 5 is provided and can be integrated into an optical system, in a step 127, which is a target optical system for assembly.

If, in the step of decision 123, the deviations are determined to be larger than the threshold, in a step 129 the mirror 5 will be processed at such locations, where the deviations are larger than the threshold, in order to approximate the reflecting surface 3 to the target shape thereof. Subsequently, the processing will continue at step 115, and the mirror 5 will be disposed in the beam of measuring light 44 again. Then the interferometric measurement, the evaluation thereof and the decision with respect to the finishing of the mirror, according to the steps 117 to 129, will be repeated, until the shape of the reflecting surface 3 satisfies the specification and the mirror will finally be provided in the step 127.

The above mentioned threshold values, being the basis for a decision whether the shape of the optical surface to be manufactured satisfies the specification thereof, will depend on the application of the optical surface in the optical system for which the optical element is designed. For example, if the optical surface is a lens surface in an objective for imaging a reticle structure onto a resist in a lithographic process for semiconductor manufacturing using radiation of a wavelength λ=193 nm, such threshold value may be in a range of about 1 nm to about 10 nm. When the optical element will be used as a mirror surface in an imaging objective, using EUV (extreme ultraviolet) radiation with a wavelength of for example λ=13,5 nm, the threshold value will be in a region of about 0.1 nm to 1.0 nm. It is to be noted that it is not necessary that the above mentioned threshold is a constant threshold over the whole area of the optical surface. It is possible that the threshold is dependent on, e.g., a distance from a center of the optical surface or some other parameters. In particular, plural thresholds may be designed each for different ranges of spatial frequencies of differences between the measured surface and its target shape. The processing of the optical surface can comprise plural suitable processing methods, as for example milling, grinding, loose abrasive grinding, polishing, ion beam figuring, and magneto-rheological figuring.

The finishing of the optical surface can comprise a final polishing and applying a coating. The coating can comprise applying reflective coating, an anti-reflective coating and a protective coating. The coatings can be applied using plural different suitable methods, as for example sputtering. The reflecting coating can comprise a plurality of layers, as for example ten layers made of dielectric materials, being constituted by alternating two different dielectric materials, as for example molybdenum oxide and silicon oxide. The different layers can be produced having thicknesses, as for example about 5 nm, and will be adjusted to the wavelength of the radiation, which is to be reflected from the optical surface. The antireflective coating shall reduce reflections of radiation from the optical surface, as for example a lens, and can comprise plural layers of different materials, as for example magnesium fluoride, lanthanum oxide, and other. The reflective coating and the antireflective coating finally can be covered by a passivating protective coating, which can be formed by different suitable materials, as for example ruthenium.

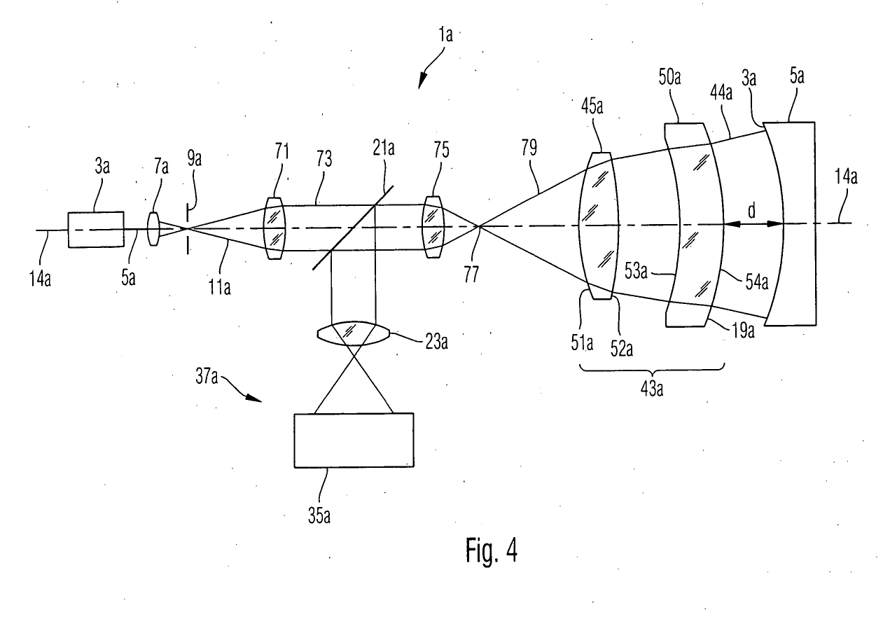

FIG. 4 shows an interferometer system 1a according to a further embodiment of the method of processing an optical element having an optical surface. Here, the optical element is a mirror 5a with a reflecting surface 3a which is measured by a beam of measuring light 44a. For the generation of the beam of measuring light 44a a source of laser light 4a, a collimator 7a, and a beam stop 9a are supplied, in order to generate a diverging beam 11a, which is formed by a collimating lens 71 into a parallel beam 73, wherein a beam splitter 21a is disposed. The parallel beam 73 is converted by a further collimating lens 75 into a converging beam, which changes to a diverging beam 79, after a crossover 77, having wavefronts with spherical shape. The beam 79 enters into an interferometer optics 43a, which has two lenses 45a and 50a. The lens 45a has two lenses surfaces 51a and 52a, and the lens 50a has two lens surfaces 53a and 54a. The lens surface 54a acts also as a Fizeau surface 19a of the interferometer system 1a. Portions of the beam being reflected from the Fizeau surface 19a will be guided via the beam splitter 21a onto a photosensitive substrate 35a of a camera 37a. The reflecting surface 3a to be manufactured is disposed within a small distance d of about 10 mm to 20 mm from the Fizeau surface 19a. The reflecting surface 3a has an aspherical shape. Also the Fizeau surface 19a has an aspherical shape, which, in the direction of a beam of measuring light 44a being provided by the interferometer optic 43a, has a same distance d from the reflecting surface 3a to be measured, at all locations. Radiation being reflected from the reflecting surface 3a will also be guided to the photosensitive substrate 35a and will be superimposed with the backreflected reference radiation, thus resulting into an interference pattern. Background information for performing an interferometric measurement using the interferometer system 1a, shown in FIG. 4, can be found in the U.S. 2003/0002048 A1, the entire disclosure of which is incorporated herein by reference.

Because of the small distance d of the reflecting surface 3a to be manufactured from the Fizeau surface 19a, serving as a reference surface, the latter has to be of substantially the same aspherical shape as the target shape of the reflecting surface 3a. Therefore, the Fizeau surface 19a has to be manufactured with at least a same or even higher precision as the reflecting surface 3a has to be manufactured. This problem is solved by designing a separate interferometer optics for manufacturing the Fizeau surface 19a, and the Fizeau surface 19a will then be measured with this separate interferometer optics, in order to determine deviations between the Fizeau surface 19a and the target shape thereof. For this, the method as set forth above referring to FIGS. 1 to 3, will be used.

In the exemplary embodiments described above, the exemplary interferometer optics utilize refractive lenses to generate the beam of measuring light. But it is also possible to use a diffractive hologram, such as, for example, a computer generated hologram (CGH) in order to form the beam of measuring light.

Also, the exemplary embodiments described above utilize Fizeau-type interferometers. However, those of ordinary skill in the art will appreciate that other exemplary interferometer types can be used. One example is a Twyman-Green-type interferometer, which is by example explained in chapter 2.1 of the textbook of Daniel Malacara, as cited above. Further examples are Michelson-type interferometers which are by example also explained in chapter 2.1 of the textbook of Daniel Malacara. Further examples are Mach-Zehnder-type interferometers which are by example mentioned in chapter 2.6 of the textbook of Daniel Malacara. Further examples are point-diffraction-type interferometers, which are described for example in U.S. Pat. No. 5,548,403 and in the article “extreme ultraviolet phase-shifting point-diffraction interferometer: a wavefront metrology tool with subangstrom reference-wave accuracy” by Patrick P. Naulleau et al., Applied Optics-IP, volume 38, issue 35, pages 7252 to 7263, December 1999. The entire contents of these documents and book chapters are incorporated herein by reference.

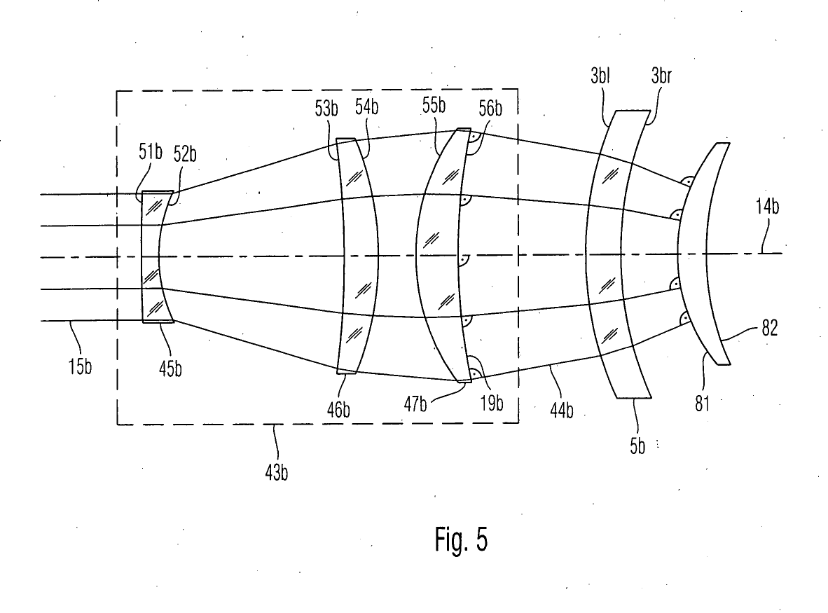

FIG. 5 shows an interferometer system 1b for the use of a further embodiment of the method of processing an optical element having an optical surface. Here, the optical element is a lens 5b having two optical surfaces 3bl and 3br. The beam of measuring light 44b is generated in a way similar to the generation of the measuring light 44, as is shown in the example of FIG. 1. Therefore, details concerning this are omitted in the following description. But other than the example mentioned above an optical surface 56b of the lens 47b serves as a Fizeau surface 19b. The optical surface 19b is manufactured, e.g., according to one of the examples of a method of processing an optical element for the manufacturing of an optical element in reflection, as is already described above. Thus, the optical surface 56b has a desired aspherical shape. The beam of measuring light 44b generated by the interferometer optics 43b emerges substantially orthogonal at each point of the lens surface 56b of the lens 57b serving as a Fizeau surface 19b, transverses the lens 5b to be measured having its optical surfaces 3bl and 3br, to be incident onto a surface 81 of a mirror 82. This mirror 82 has a spherical shape of high precision. The light being reflected from the mirror 82 then traverses the lens 5b, such that it will superimpose with the reference light reflected from the Fizeau surface 19b to form interference patterns, which can be detected by a detector, not shown. The evaluation of the detected interference pattern according to the invention allows a processing of the lens 5b.

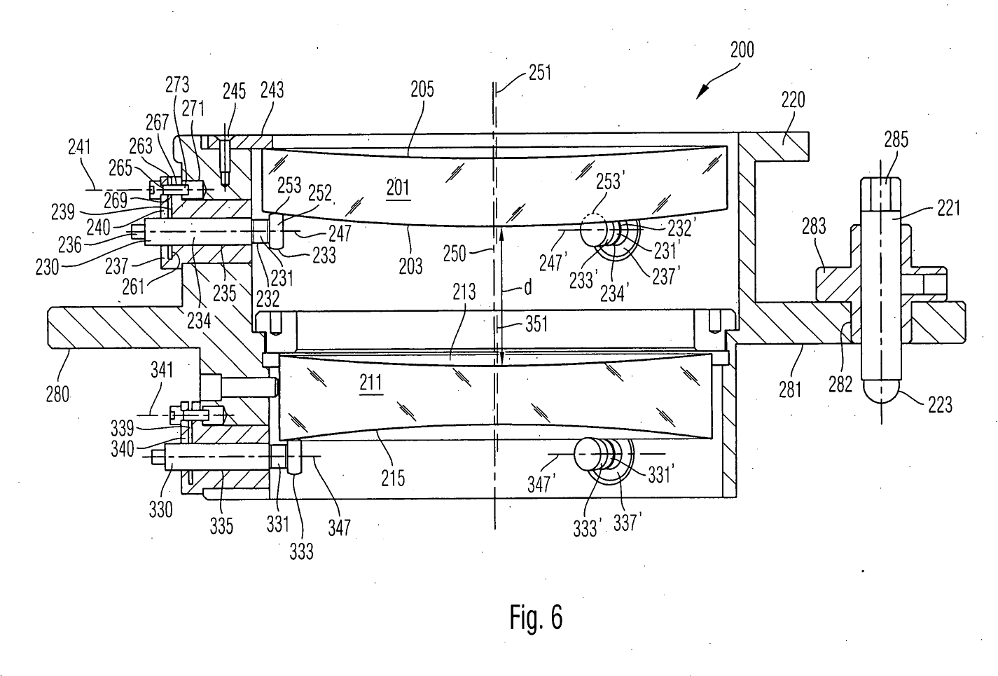

Referring to FIG. 6, an optical apparatus 200 is shown by example. It comprises two lenses 201, 211 and a mounting structure 220, in order to support the two lenses 201, 211, wherein the mounting structure is configured such that a distance d between the two adjacent lenses and a relative orientation of the two adjacent lenses are adjustable. At least one of the lenses, as for example lens 201, has a curved optical surface 203. The mounting structure 220 provides three supporting locations: one shown by 253, one shown by 253′ and a third similar supporting location (not shown in the view illustrated in FIG. 6) engaging the curved optical surface 203 for supporting the lens 201. The supporting locations (collectively referred to as “supporting locations 253”) are provided at respective ends of three adjustment members. In the example of FIG. 6, the adjustment members comprise a threaded bolt 231 connected to a seat 252, a threaded bolt 231′ connected to a similar respective seat, and a third threaded bolt connected to a similar respective seat (not shown in the view illustrated in FIG. 6). The threaded bolt 231 has a male threaded portion 232 on a portion of its surface.

The mounting structure provides three support portions wherein each of the support portions supports a respective adjustment member. In the example of FIG. 6, three threaded portions (threaded portion 234 and two similar threaded portions) are provided, wherein each of the threaded portions is in threaded engagement with a respective threaded bolt (e.g., threaded bolt 231 and two others, collectively referred to as “threaded bolts 231”) and wherein each threaded portion (e.g., 234 and two others, collectively referred to as “threaded portions 234”) is formed within a respective bushing (e.g., 237 and two others, collectively referred to as “bushings 237”). The orientations of the threaded bolts 231 are determined by their respective central (e.g., longitudinal) axes (e.g., axis 247, axis 247′, and a third central axis not shown in the view illustrated in FIG. 6, collectively referred to as “central axes 247”). The male threaded portion (e.g., 232 and 230) of each of the threaded bolts 231 engages the respective female threaded portions 234. The three bushings 237 each provide a slit (e.g., 239). The slit 239 has an open portion 263 and is integral with the bushing 237 at a closed portion 261. In a subportion of the open portion 263 the bushing 237 has an internal thread 267 on both sides of the recess being constituted by the slit 239, the orientation of which is given by the axis 241. A male threaded portion 269 of a screw 265 is in threaded engagement with the internal thread 267. Within the mounting structure 220 at a point of intersection of the axis 241 with a wall of the mounting structure 220 a recess 271 is formed to incorporate an end portion 273 of the screw 265. By screwing the screw 265, such that it moves towards the mounting structure 220, both parts of the open portion 263 of the bushing 237 come closer. This leads to a clamping effect of the threaded bolt 231 in a portion 240 onto the threaded bolt 230 with respect to the mounting structure 220. By this the position of the threaded bolt 231 is secured with respect to the mounting structure 220. The threaded bolt 231 has at another end, facing away from the mounting structure 220, a projection 236. The projection 236 provides a portion for being engaged by a tool, in order to be able to turn the threaded bolt 231. For example, this portion for engagement can be a slit for a screw driver, but any other form for being engaged by a suitable tool for turning the threaded bolt 231 can be used.

The condition of the threaded bolt 231 in the bushing 237 as set forth above has been described in detail as an example for only one threaded bolt 231. The same holds for threaded bolt 231′ and the third threaded bolt (not shown in the view illustrated in FIG. 6) within their respective bushings 237′ and a third bushing (not shown in the view illustrated in FIG. 6).

Further, a holding plate 243 is provided, and which is fixed to the mounting structure 220 by means of a screw 245, in order to prevent inadvertent movements of the optical element 201.

Further, the mounting structure 220 has a circumferential projecting rim 280, 281. A portion 281 of the rim projects further than a portion 280 of the rim. The portion 280 of the rim comprises an opening 282 for incorporating a bushing 283. The bushing 283 incorporates, parallel to an orientation 250 of the mounting structure 220, a cylinder bolt 221. This cylinder bolt has on one end a spherical end portion end on its other end a cylindrical recess 285.

FIG. 6 shows a second optical element being supported by components identical to the ones as set forth above. These components are designated by reference numerals of the form 3xx instead of 2xx, but provide the same functionality as is already described with respect to the components designated by 2xx.

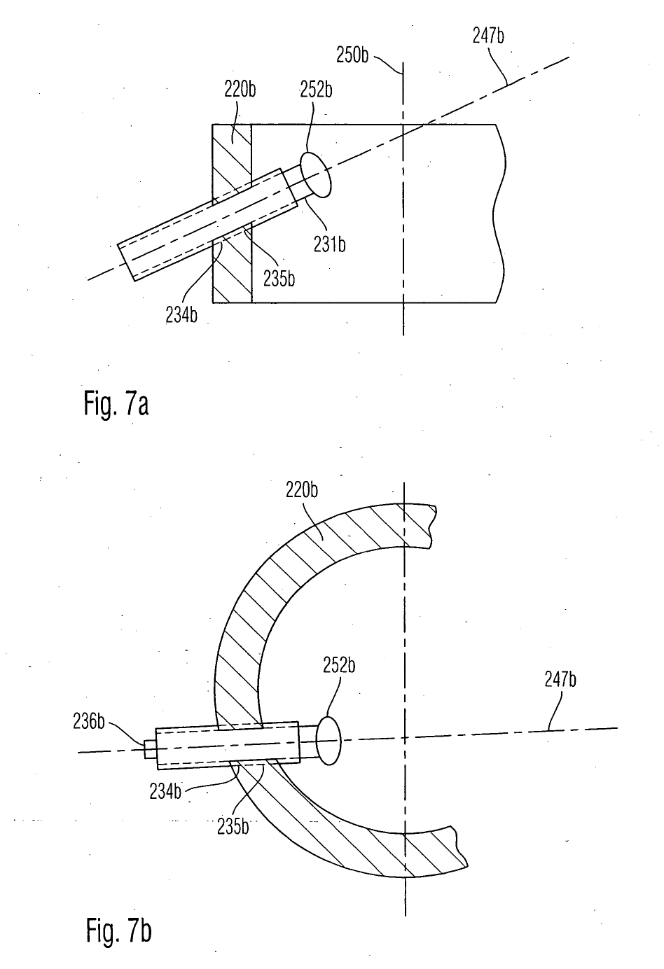

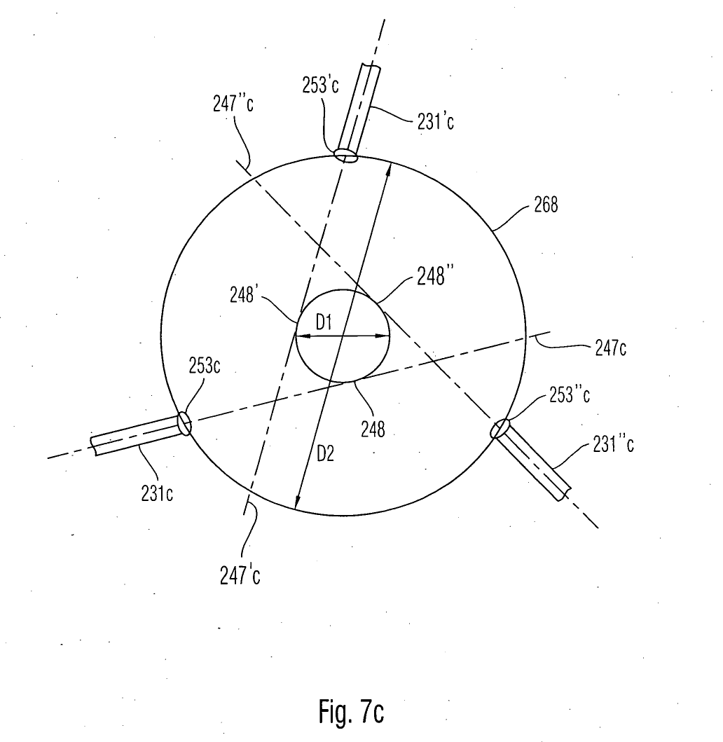

In the example described above the central axes 247 of the threaded bolts 231 are arranged in one plane and intersect in one point which is located on a central axis 250 of the mounting structure 220. But the threaded bolts (e.g., 231b, in FIG. 7a) can also be constituted with other orientation of their axes (e.g., 247b, in FIG. 7a) when the threaded portions (e.g., 234b) are appropriately formed, as will be shown referring to FIGS. 7a, 7b and 7c.

FIGS. 7a and 7b show in a view as seen from a side (FIG. 7a) and in view as seen from above (FIG. 7b) a general arrangement of the axis 247b of the threaded bolt 231b. FIG. 7c shows a schematic view of the condition as shown in FIGS. 7a and 7b, as seen from above, also showing the other two of the three threaded bolts. FIG. 7a shows the threaded bolt 231b within its corresponding threaded portion 234b as seen from the side. The threaded portion 234b is manufactured into the mounting structure 220b having a general angle with respect to an axis 250b of the mounting structure 220b. Identical reference numerals as in the foregoing designate same parts.

FIG. 7B shows the threaded bolt 231b as seen from above in the same condition as in FIG. 7a. The general orientation of the threaded portion 234b has the effect, as can be seen by comparing the FIG. 7a with 7b, that the axis 247b of the threaded bolt has a general orientation.

But not any orientation of the threaded portions 234b provides the possibility of adjusting the optical elements with respect to a distance between each other and with respect to adjusting a relative orientation between each other. The generally oriented axes 247b, 247′b and 247″b should satisfy a relation, which is shown schematically in FIG. 7c: the axes 247c, 247′c and 247″c of the three threaded bolts 231c, 231′c and 231″c should be oriented such that they define a smallest first mathematical sphere having the central axes as tangent lines thereto. The smallest first mathematical sphere has a first diameter D1, as is shown in FIG. 7c, the points of tangents being designated by 248, 248′ and 248″. Further, the three supporting locations 253c, 253′c and 253″c define a smallest second mathematical sphere 268 extending to the three supporting locations 253c, 253′c and 253″c as is shown in FIG. 7c. The diameter D1 should be smaller than a second diameter D2 of the second mathematical sphere 268 (e.g., D1 can be smaller than half of D2).

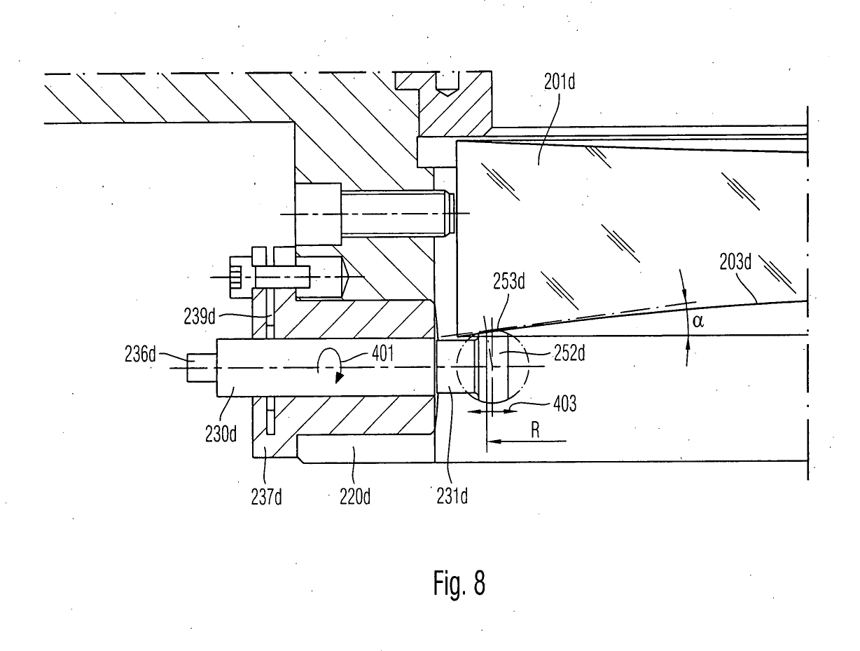

FIG. 8 shows by example how this exemplary embodiment of the optical apparatus according to the invention works. Here, a portion of FIG. 6 is shown; identical reference numerals designate same parts. Here, the first optical element 201d is engaged via its curved surface by the supporting locations (253d and two similar supporting locations) of the seats (252d and two similar seats). By turning the threaded bolt 231d according to a direction of rotation 401, the threaded bolt 231d will move according to a direction 403 to the left or to the right on the figure. As the optical element 201d has a curved surface 203d, the supporting location 253d moves relative to the local slope designated by α. This causes the shown portion of the optical element 201d to move up or down on the figure. This results in a tilting movement of the first optical element 201d and thus to a change of an orientation of the first optical element relative to the orientation of the second optical element. However, if all three threaded bolts are actuated in a same manner, the first optical element 201d will experience a translation as a whole, such that an adjustment of a distance between the first optical element and the second optical element is effected.

In the above-described example, threaded bolts serve as the adjustment members, and threaded portions serve as support portions that support the adjustment members. However, it will be understood that any suitable adjustment members, support portions, and driving mechanisms to drive the adjustment members can be used, which can provide suitable motion of the supporting locations, such as, for example, motion 403 of supporting location 253d illustrated in FIG. 8.

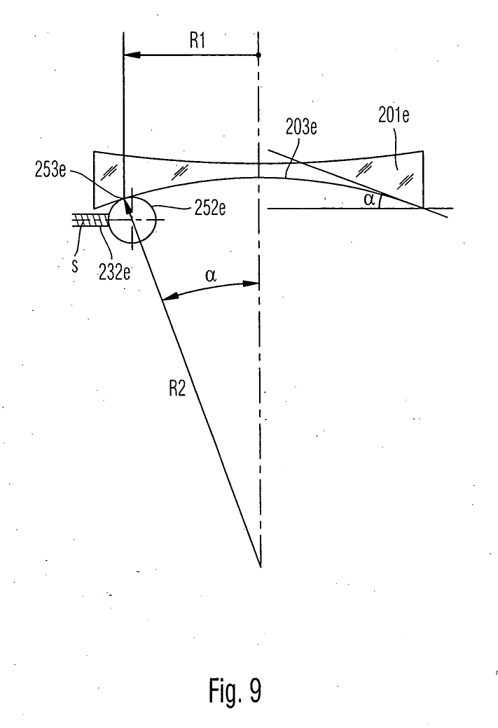

FIG. 9 shows by way of example a dimensioning of a thread pitch as of a thread 232e of a threaded bolt in relation to a given supporting radius R. If, for example, the supporting radius R1 is 60 cm and a radius of curvature R2 of the optical element is 437.2 mm, so, taking a slope a of the surface of the optical element 203e into account, a thread pitch of s=0.35 mm/turn is to be defined, according to
sin α≈60/437.2=7.888°,
which leads to a pitch h of the screw thread of the thread 232e of
h=0.00485 mm/turn
Thus, in summary, exemplary embodiments provide a method of processing an optical element, comprising: testing the optical surface of the optical element using an interferometer optics for generating a beam of measuring light; wherein the interferometer optics has a plurality of optical elements which are configured and arranged such that the measuring light is substantially orthogonally incident on a reflecting surface, at each location thereof; and wherein the method further comprises: measuring at least one property of the interferometer optics, disposing the optical surface of the optical element at a measuring position relative to the interferometer optics within the beam of measuring light, and performing at least one interferometric measurement; determining deviations of the optical surface of the first optical element from a target shape thereof, based on the interferometric measurement and the at least one measured property of the interferometer optics.

The present invention has been described by way of exemplary embodiments to which it is not limited. Variations and modifications will occur to those skilled in the art without departing from the scope of the present invention as recited in the appended claims and equivalents thereof.

1. A method of processing a first optical element having an optical surface, the method comprising:
testing the optical surface of the first optical element using a first interferometer,
wherein the first interferometer comprises an interferometer optics for generating a beam of measuring light, and
wherein the interferometer optics has a plurality of optical elements which are configured and arranged such that the measuring light is substantially orthogonally incident on a reflecting surface, at each location thereof, the reflecting surface being disposed at a predetermined distance from the interferometer optics in the beam of measuring light;
measuring at least one property of the interferometer optics, wherein the at least one property comprises at least one of
a parameter of a shape of an optical surface of at least one optical element of the plurality of optical elements of the interferometer optics,
a distance between two different optical surfaces of the interferometer optics, and
an index of refraction of at least a portion of a medium disposed between two adjacent optical surfaces of the interferometer optics;
disposing the optical surface of the first optical element at a measuring position relative to the interferometer optics within the beam of measuring light, and performing at least one interferometric measurement by superimposing reference light with measuring light reflected from the reflecting surface; and
determining deviations of the optical surface of the first optical element from a target shape thereof, based on the interferometric measurement and the at least one measured property of the interferometer optics.

2. The method of claim 1, wherein the parameter of the shape of the optical surface of the at least one optical element of the interferometer optics comprises a radius of curvature of the optical surface of the at least one optical element of the interferometer optics.

3. The method of claim 1, wherein the at least one optical element of the interferometer optics is a lens and wherein the medium disposed between the two adjacent optical surfaces is a material from which the lens is made.

4. The method of claim 3, wherein the parameter of the shape of the optical surface of the at least one optical element of the interferometer optics comprises a deviation of the optical surface of the at least one lens from a target shape thereof, the target shape of the optical surface of the at least one optical element of the interferometer optics being predetermined by a design of the interferometer optics.

5. The method of claim 3, wherein the measuring of the at least one property of the interferometer optics comprises measuring the index of refraction of the material of the lens at a first location and at a second location which is different from the first location.

6. The method of claim 1, wherein the medium disposed between the two adjacent optical surfaces of the interferometer optics is a gas disposed between the two adjacent optical surfaces.

7. The method of claim 6, wherein the measuring of the at least one property of the interferometer optics comprises determining a temperature of the gas.

8. The method of claim 6, wherein the measuring of the at least one property of the interferometer optics comprises determining a pressure of the gas.

9. The method of claim 6, wherein the measuring of the at least one property of the interferometer optics comprises determining a humidity of the gas.

10. The method of claim 1, wherein the optical surface of the first optical element provides the reflective surface when the optical surface of the first optical element is disposed substantially at the measuring position in the beam of measuring light.

11. The method of claim 1, wherein the reflecting surface is separate from the optical surface of the first optical element, and wherein the first optical element is traversed by the beam of measuring light when the optical surface of the first optical element is disposed substantially at the measuring position in the beam of measuring light.

12. The method according to claim 1, wherein the determining of the deviations of the optical surface of the first optical element from the target shape comprises:
changing design data of the interferometer optics, wherein the design data is specified by a design of the interferometer optics, and wherein changing the design data is based on the at least one measured property; and
performing a ray tracing computation of rays of the beam of the measuring light traversing the interferometer optics based on the changed design data of the interferometer optics.

13. The method of claim 1, wherein the optical surface of the first optical element has an aspherical shape.

14. The method of claim 1, wherein the interferometer optics has a reference surface which reflects the reference light, and which is traversed by the beam of measuring light.

15. The method of claim 1, further comprising processing the optical surface of the first optical element based on the determined deviations.

16. The method of claim 15, wherein the processing is performed only if the determined deviations exceed at least one predetermined threshold.

17. The method of claim 15, wherein the processing comprises at least one of milling, grinding, loose abrasive grinding, polishing, ion beam figuring, magneto-rheological figuring, and finishing the optical surface of the first optical element.

18. The method of claim 17, wherein the finishing comprises applying a coating to the optical surface of the first optical element.

19. The method of claim 18, wherein the coating comprises at least one of a reflective coating, an anti-reflective coating, and a protective coating.

20. A method of processing a second optical element having an optical surface, the method comprising:
providing a first optical element having an optical surface of substantially a predetermined target shape by, the predetermined target shape of the first optical element being obtained by
measuring the optical surface of the first optical element using the method of claim 1 for determining deviations of a shape of the optical surface of the first optical element from its predetermined target shape, and
processing the optical surface of the first optical element based on the determined deviations for reducing the deviations of the shape of the optical surface of the first optical element from its predetermined target shape;
incorporating the first optical element in a second interferometer;
performing a second interferometric measurement of the optical surface of the second optical element using the second interferometer; and
determining deviations of the optical surface of the second optical element from its target shape based on the second interferometric measurement.

21. The method of claim 20, further comprising processing the optical surface of the second optical element based on the determined deviations of the optical surface of the second optical element from its target shape.

22. An optical apparatus comprising:
at least two lenses and a mounting structure adapted to support the at least two lenses relative to each other, wherein the mounting structure is configured such that at least one of a distance between two adjacent lenses of the at least two lenses and a relative orientation of the two adjacent lenses is adjustable;
wherein at least one lens of the at least two lenses has a curved optical surface;
wherein the mounting structure provides three supporting locations engaging the curved surface for supporting the lens having the curved optical surface;
wherein each of the supporting locations is provided at a respective end of an adjustment member;
wherein the mounting structure provides three support portions, wherein each of the support portions supports a respective adjustment member;
wherein the adjustment members are oriented such that central axes of the three adjustment members define a smallest first mathematical sphere having the central axes as tangent lines thereto, wherein the three supporting locations define a smallest second mathematical sphere extending to the three supporting locations, and wherein a first diameter of the smallest first mathematical sphere is less than half of a second diameter of the smallest second mathematical sphere.

23. The optical apparatus of claim 22, wherein the three central axes of the adjustment members each extend substantially transverse to an optical axis of the lens having the curved surface.

24. The optical apparatus of claim 22, wherein the at least two lenses have a substantially common optical axis and wherein the adjustment members each extend substantially transverse to the common optical axis.

25. The optical apparatus of claim 22, wherein the first diameter is substantially zero.

26. The optical apparatus of claim 22, wherein the ends of the adjustment members have convex surfaces, providing the supporting locations.

27. The optical apparatus of claim 22, wherein the adjustment members are threaded bolts, wherein the support portions are threaded portions, and wherein
each of the threaded portions is in threaded engagement with a respective threaded bolt.

28. An interferometer comprising:
a light source for generating a beam of measuring light; and
an interferometer optics providing a beam path of the beam of the measuring light;
wherein the interferometer optics comprises the optical apparatus of claim 22.
